(19) United States
(12) Patent Application Publication
(10) Pub. No.: US 2010/0177902 A1
(43) Pub. Date: Jul. 15, 2010

(54) Audio transmission system

(75) Inventors: Allen Kam Kwong Wong, Hong Kong (CN); Wai Ho Cheung, Hong Kong (CN)

Correspondence Address: DAVID W. WONG, 46 WILLOWBROOK ROAD, THORNHILL, ON, L3T 4W9, CA

(73) Assignee: KING SUM CHU

(21) Appl. No.: 12/319,990

(22) Filed: Jan. 15, 2009

(51) Int. Cl. H04H 20/48; H04L 25/49; H04L 25/03

(52) U.S. Cl. 381/3; 375/296; 375/297

(57) ABSTRACT

An audio transmission system of an FM carrier frequency signal conveys an analog audio signal with minimum distortion, high signal to noise ratio, and minimum phase distortion. The system employs digital data processing blocks to generate a VHF FM carrier signal which is subsequently converted to an UHF FM carrier frequency signal for transmission wirelessly to a receiver for reproducing the audio signal.

### BACKGROUND OF THE INVENTION

1. Field of the invention

This invention relates to an audio transmission system for modulating an analog signal to generate an UHF FM radio frequency carrier signal. More particularly, it relates to an audio transmission system for providing an FM carrier frequency signal conveying analog audio signal with minimum distortion, high signal-to-noise ratio, and minimum phase distortion.

2. Background Art

Commonly in the transmission of a UHF FM carrier frequency signal, the left and right channel are firstly compressed and then multiplex (MPX) by using either a microprocessor, or a specific solid state integrated circuit to form the stereo composite signal. The multiplex signal contains information of the L+R, L−R and the 19 KHz pilot tone. This composite signal is further modulated into the carrier frequency by an oscillator.

In order to provide stability to the transmission system, it is a common practice to use a free running dielectric resonator oscillator (DRO), a VCXO, or simply a VCO together with a phase lock loop (PLL) circuit. The merit of a DRO is that it has a high Q-factor, thus it provides a high signal-to-noise ratio (SNR); however, if the Q-factor of the oscillator is too high, it will deteriorate the audio frequency response and it is also most unfavorable for the producing the low frequencies in the signal. A further drawback of a DRO is that it is too susceptible to external interferences, such as temperature change, and/or ambient capacitance or inductance change, which causes the carrier frequency to drift, and thus adding noise to the system.

More and more systems now employ a PLL system to stabilize the carrier frequency, which contains a VCO (K_{VCO}/s), a loop filter (LF, Z(s)) and a phase detector (PD, Kφ), and a reference crystal clock. However, the stability of a PLL system requires careful tuning of the loop filter's phase margin and loop bandwidth. Furthermore, matching of the PLL can be time consuming and difficult to obtain. Therefore, designing 30 a PLL system for audio transmission is demanding in that the loop filter would limit the quality of its performance. It is a normal practice to tune the loop filter to a phase margin at 40-55 degrees. For an audio signal of 15 KHz or higher, a narrow loop bandwidth (ωc) is required. However, a narrower loop bandwidth will cause a higher error in the RMS phase, or sometimes the residual FM, in the signal. For the above reason, modulation of the audio signal to the carrier becomes difficult without at the expense of the signal-to-noise ratio (SNR). There is always a tradeoff among the signal-to-noise ratio (SNR), the lock time, the loop stability, and the frequency response. If the loop filter has a high stability to external interference i.e. having a wide loop bandwidth, the low frequency interference will not be modulated because the PLL system will track out the signal. This will result in a dull frequency response when it is received by the receiver. On the other hand, if loop bandwidth is too narrow, the RMS phase error will degrade the SNR. For the application of modulating an audio signal below 5 KHz, such as the traditional FM system, for example, of a telephone system, it does not create a major concern, since it is mainly employed for voice communication. Unfortunately, if a system is required to broadcast an audio signal up to 15 KHz or higher, as usually in the upper end frequency in an FM system, this type of system is inadequate.

Another drawback of employing a PLL system in this application is that group delay of different frequency components contained in the audio signal would occur due to the loop response characteristic. As it is commonly known, the relative phase difference of an audio signal has an impact on the quality of the sound. Furthermore, the linearity of the VCO is also important in that the design of a very linear VCO is a difficult task and the cost for providing such a system is high.

U.S. Pat. No. 5,272,525 to Robert L. Borchardt et al describes a wireless transmission system with particular emphasis on the use of an FM radio in the receiver to receive a signal above 900 MHz. U.S. Pat. No. 5,666,422 to Robert N. Harrison et al teaches the use of IR for the wireless transmission of audio signal for surround speakers. U.S. Pat. No. 5,299,264 to Larry Schatz et al describes the usage of a varactor modulator for transmission in the 900 MHz band. U.S. Pat. No. 5,666,658 and No. 6,215,981 both to Robert L. Borchardt et al describes the use of a ceramic resonator stabilized FM transmitter for audio signal transmission. U.S. Pat. No. 6,466,832 to Benjamin Zuqert et al describes the transmission in using digital modulation in which the audio signal is reconstructed in the receiver. U.S. Pat. No. 7,212,787 to Eric Wu et al further describes a wireless audio transmission system employing pulse width modulation.

There are various methods developed for modulating a mono or stereo audio signal to a carrier frequency signal for transmission via a wireless media. However, due to the reasons described above, the performance of these methods is not satisfactory. Moreover, there are transmission systems using digital methods, but the structure of such digital systems is complex. Some systems employ a higher transmission frequency such as 2.4 GHz which is better in performance, but the cost of the material for constructing such systems is high so that they are not commercially viable in price.

### SUMMARY OF THE INVENTION

It is the object of the present invention to provide a transmission system of an FM carrier frequency signal by conveying an analog audio signal with minimum distortion, high signal-to-noise ratio, and minimum phase distortion. The transmitter of this system includes a single solid state device with a built-in digital signal processor (DSP) for direct digital synthesis (DDS) which is a technique for using digital data processing blocks as a means to generate an output signal having a frequency and tunable with reference to a clock having a fixed frequency. A solid state device is utilized as a synthesizer. It facilitates tuning under complete digital control; and it offers a high signal-to-noise ratio in the output signal. The transmitter also includes a local oscillator, a mixer for up-conversion, and at least a radio frequency power amplifier. The solid state device will first convert the analog signal to a digital signal. The DSP within the device will then digitally generate the stereo composite signal which is synthesized to a low frequency FM signal. The low frequency FM signal is then up-converted to a VHF FM carrier signal having a frequency range typically of 76 to 108 MHz. The VHF FM carrier signal is then further up-converted to an UHF FM carrier frequency signal of either 863 to 865 MHz or 902 to 928 MHz by a local oscillator.

Change of channel in the transmission is achieved by either changing the frequency of the VHF FM carrier signal of the solid state integrated circuit or the local oscillator or both.

A band pass filter or alternatively a low pass filter is added in the circuit to remove any undesired harmonics or inter-modulation signals during the up-conversion process. At least a radio frequency amplifier is also included for maximum allowable power delivered to the antenna of the transmitter.

The transmission system of the present invention provides a means of transmitting a mono or stereo audio signal using UHF to offer a better performance than the conventional system, as well as less cost such that it is commercially lower in price.

### BRIEF DESCRIPTION OF THE DRAWINGS

Other objects and advantages of the present invention will become apparent from the following detailed description of the preferred embodiments thereof in connection with the accompanying drawings in which

FIG. 1 is a schematic block diagram showing the overall construction of the audio transmission system of the present invention.

FIG. 2 is a graphical illustration showing the up-conversion process of the system of the present invention of utilizing the upper side frequency in which the local oscillator is oscillating at a frequency lower than the desired UHF FM carrier signal.

FIG. 3 is a graphical illustration showing the method of changing channel in the present system by changing the transmitted frequency of the single chip IC in the up-conversion process.

FIG. 4 is a graphical illustration showing another up-conversion process employing the lower side frequency in which the local oscillator is oscillating at a frequency higher than the desired UHF FM carrier signal.

FIG. 5 is a graphical illustration showing the method of changing channel in the present system by varying the transmitted frequency of the single chip IC when using the lower side frequency.

FIG. 6 is a schematic block diagram showing the single chip RF integrated circuit in the present system having a digital signal processor (DSP) operative for generating a VHF radio frequency carrier signal.

### DETAILED DESCRIPTION OF THE PREFERRED EMBODIMENTS

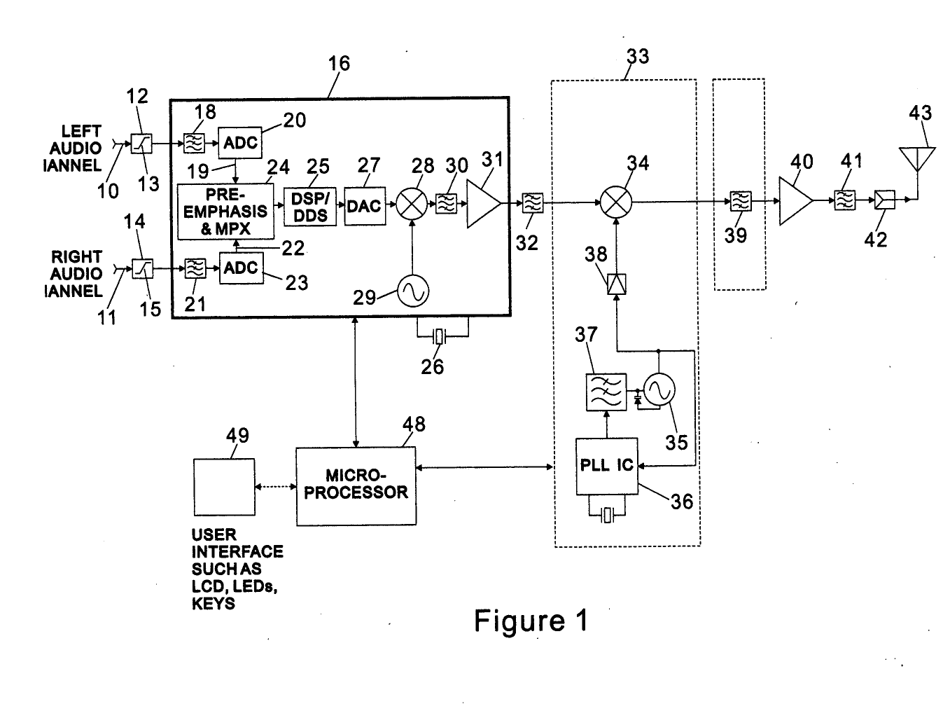

With reference to the drawings, the system of the present invention is best shown in FIG. 1 illustrating the exemplary embodiment of the transmission of a stereo signal having a left audio channel input signal 10 and a right audio channel input signal 11. The amplitude of the high frequencies of the left audio channel input signal 10 are increased in an optional pre-emphasis circuit 12 to provide a left channel pre-emphasized signal 13, similarly the amplitude of the high frequencies of the right audio channel input signal 11 are increased in an optional pre-emphasis circuit 14 to provide a right channel pre-emphasized signal 15. The left channel pre-emphasized signal 13 and the right pre-emphasized signal 15 are inputted into an RF circuit 16 to form a VHF FM carrier signal 17. The left channel pre-emphasized signal 13 is refined in a low pass filter 18 which permits low frequency signal to pass but attenuates signals with frequencies higher than a pre-determined cut-off frequency. The filtered left channel pre-emphasized signal 13 is converted to a left channel digital signal 19 by an analog to digital converter (ADC) 20. Similarly, the right channel pre-emphasized signal 15 is filtered by a low pass filter 21 which passes low frequency signal but attenuates signals with frequencies higher than the same pre-determined cut-off frequency. The filtered right channel pre-emp signal 15 is converted to a right channel digital signal 22 by another ADC 23. Both the left channel digital signal 19 and the right channel digital signal 22 are inputted into a pre-emphasis multiplexer (MPX) 24 for multiplexing the two digital signals as well as increasing the amplitude of the higher frequency of the mixed signal to provide a composite digital signal with 19 KHz pilot tone. The composite digital signal is further processed by an internal digital signal processor (DSP) in a system-on-chip (SOC) IC 25 using direct digital synthesis (DDS) as a means to generate a frequency tunable output with reference to a fixed frequency clock generated by a crystal 26. The DSP is utilized as a synthesizer to make the tuning under complete digital control and it offers a high signal to noise ration to the output signal. The signal is then converted to an analog signal by a digital to analog converter 27. The digital signal processor (DSP) digitally converts the stereo signal to a digital composite signal and also synthesizes it to a low frequency FM carrier. The low frequency FM carrier is then up-converted by mixer 28 for converting it to a VHF FM carrier, typically at 76-108 MHz by a local oscillator 29 and frequency range of the VHF FM carrier is restricted by a band pass filter 30. The VHF FM carrier is amplified by an internal amplifier 31 to produce the VHF FM carrier signal 17 which is further filtered by a band pass filter or low pass filter 32 before it is passed to an up-converting circuit 33. The band pass or low pass filter 32 filters out any unwanted harmonics or inter-modulation products due to the non-linear behavior of the up-conversion by the mixer 28 and the amplifier 31.

The VHF FM carrier signal containing the frequency modulated information is further up-converted by a mixer 34 in the up-converting circuit 33 to an UHF FM carrier signal with its frequency controlled by a local oscillator 35. The local oscillator 35 is preferably designed with a high Q factor so as to minimize excess noise in the up-conversion, although lower Q factor will not seriously affect the performance of the system.

The up-converting circuit 33 is stabilized by a PLL system consisting a PLL synthesizer IC 36 a loop filter 37, a local oscillator 35, and a buffer amplifier 38 to optimize the circuit performance. In case of a PLL system for the local oscillator, wide loop bandwidth is preferred so that a minimum RMS phase error will be added in the up-conversion process. The oscillator can easily be designed to have the optimal performance at only a particular fixed frequency.

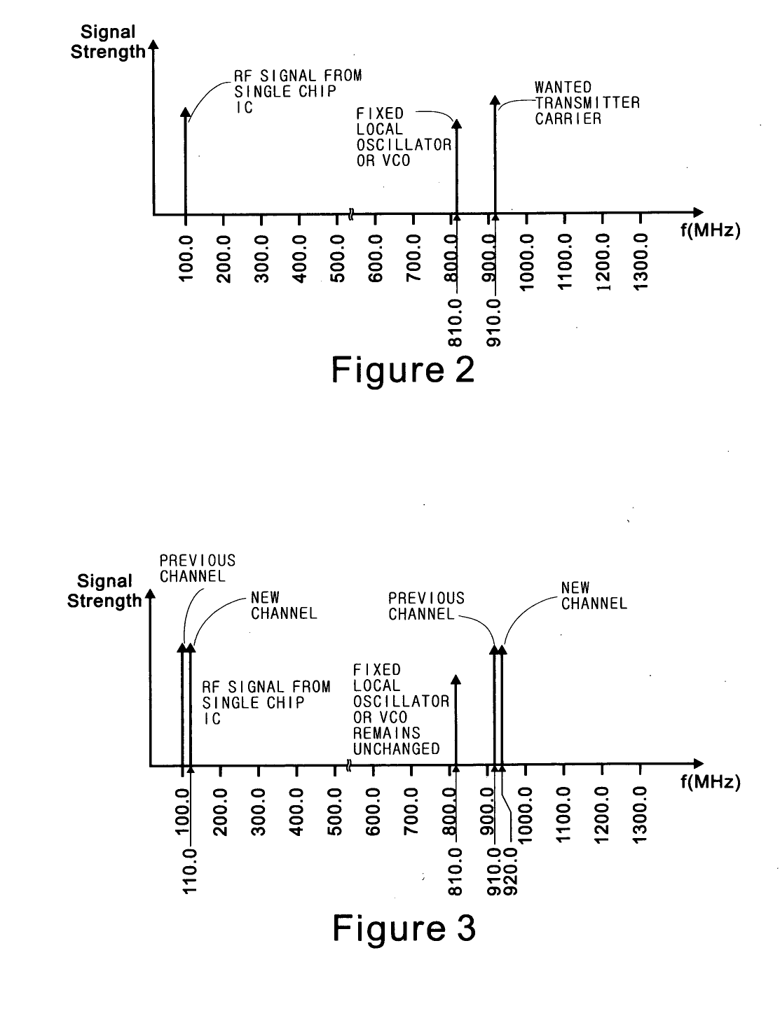

As shown in FIG. 2, the up-conversion process utilizes the upper side frequency, and the local oscillator is oscillating at a frequency lower than the desired UHF FM carrier signal.

The up-converted UHF FM carrier signal passes through a band pass filter 39 which removes unwanted harmonics and inter-modulation products. The desired UHF FM carrier signal is amplified by at least a RF tuned power amplifier 40 to provide the maximum allowable power to be delivered by the system. The amplified UHF FM signal is purified by a band pass filter 41 and is fed through a matching network 42 the antenna 43.

The operations of the RF circuit and the up-converting circuit are controlled by a microprocessor 48 having a user interface 49 in the form of LCDs, LEDs, or keys.

If the intended transmitting frequency or the desired UHF FM carrier signal is f, the VCO oscillator 33 can conveniently be designed to oscillate at a frequency of f_{LO}, therefore the up-converting circuit 31 will be programmed by the microprocessor 48 to transmit at f-f_{LO}. Change of channel is achieved by either changing the frequency of the VHF FM carrier signal of the IC chip or the local oscillator 33 or both.

As shown in FIG. 3, change of channel by changing the transmitted frequency of the IC chip can be achieved by simply programming the IC chip at a different frequency. In this process, the oscillating frequency of the local oscillator can be kept unchanged.

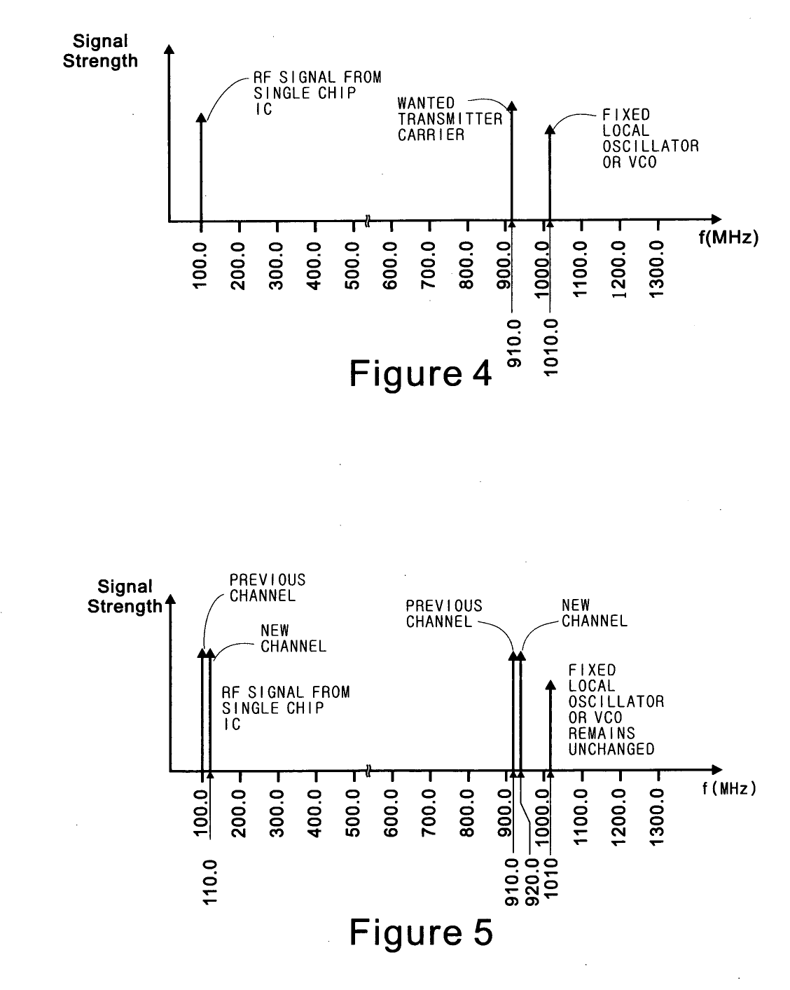

As shown in FIG. 4, another up-conversion process can be carried out by using the lower side frequency. In this case, the local oscillator will be oscillating at a frequency higher than the desired UHF FM carrier signal.

As shown in FIG. 5, change of channel can be achieved by changing the transmitted frequency of the IC chip using the lower side frequency. The process is similar to the up-conversion process of using the upper side frequency as shown in FIG. 2.

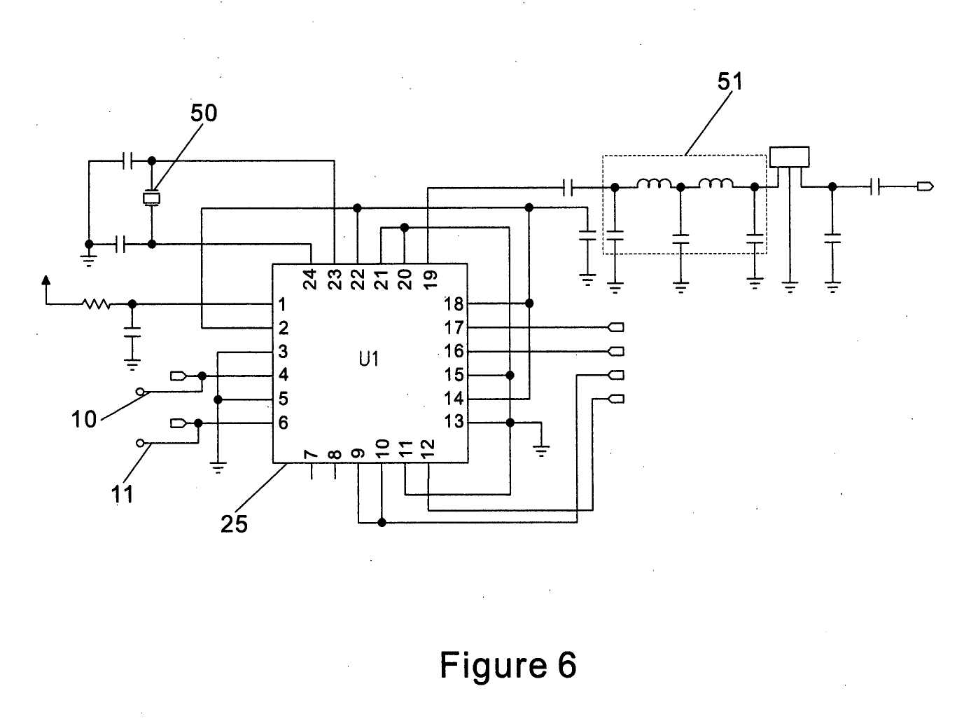

An embodiment of the digital signal processor (DSP) 25 is shown in FIG. 6 for generating the VHF frequency carrier signal in reference to a crystal 50. The VHF carrier signal is fed to an LC network 51 consisting of a series of capacitors and inductors as shown. A band pass filter is used in this case to filter any unwanted frequency from reaching the mixer 34. The left and right audio signals 10 and 11 are directly fed to the digital signal processor (DSP) 25.

In the case of a mono audio signal, multiplexing is not required at the pre-emphasis multiplex 24 and the mono audio signal may be inputted directly into the DSP 16.

The UHF FM signal resulted from the present invention can be acquired by a receiver tuned to the particular frequency and with the necessary bandwidth.

It can be understood from the above description of the preferred embodiment that the FM signal generated by the present invention is synthesized completely by digital means and it has a much higher signal to noise ratio and it can provide a much better sound quality than the signal generated by the conventional system.

Various modifications can be made without departing from the spirit of the invention or the scope of the appended claims. The illustrated embodiment set forth in this disclosure is given as an example and is in no way final or binding. In view of the above, it will be seen that several objects of the invention are achieved and other advantages are obtained. As many changes could be made in the exemplary embodiment without departing from the scope of the invention, it is intended that all matter contained in the above description shall be interpreted as illustrative and not in a limiting sense.

What is claimed is:

1. An audio transmission system comprising:
an RF means including a digital multiplexer and a digital signal processor operative for converting an audio signal to a low frequency FM carrier signal and subsequently up-converting to a VHF FM carrier frequency signal,
an up-converter means operative for converting said VHF FM carrier frequency signal to a desired UHF FM carrier frequency signal,
a filter means operative to remove unwanted frequency from said UHF FM carrier frequency signal.

2. An audio transmission system according to claim 1 including a radio frequency power amplifier means operative to amplify said UHF FM carrier frequency digital signal to a desired power.

3. An audio transmission system according to claim 2 further including an optional pre-emphasis means in said RF means and operative for improving signal to noise ratio of said VHF FM carrier frequency signal.

4. An audio transmission system according to claim 3 including a filter means operative for receiving said VHF FM carrier frequency signal from said RF means and being operative for removing any undesirable frequency therefrom prior to passing said VHF FM carrier frequency signal to said up-converter means.

5. An audio transmission system according to claim 4 including a local oscillator incorporated in said up-converter means, and selection of channel being achievable by changing oscillation frequency of said local oscillator.

6. An audio transmission system according to claim 4 wherein change of channel is achievable by changing frequency of said VHF FM carrier frequency signal from said RF means.

7. An audio transmission system according to claim 6 wherein said VHF FM carrier frequency signal has a frequency of at least 863 MHz.

8. An audio transmission system comprising,
an RF means including digital means operative for converting an audio signal to a composite digital signal and for generating a low frequency FM carrier frequency signal, and said low frequency FM carrier frequency signal being further up-converted to a VHF FM carrier frequency signal,
an up-converter means coupled to said RF means and operative for receiving said VHF FM carrier frequency signal, and up-converting said VHF FM carrier frequency signal to an UHF FM frequency signal for transmission to a receiver,
a filter means coupled to said up-converter means and being operative for filtering undesirable frequency from said UHF FM frequency signal prior to transmission.

9. An audio transmission system according to claim 8 wherein said RF means includes a digital signal processor operative for receiving said audio signal to generate said low frequency FM carrier frequency signal, and a mixer means connected to said digital signal processor and operative for converting said low frequency FM carrier frequency signal to said VHF FM carrier frequency signal.

10. An audio transmission system according to claim 9 including a second mixer means in said up-converter means operative for converting said VHF FM carrier frequency signal to said UHF FM frequency signal

11. An audio transmission system according to claim 10 including a phase lock loop circuit and a local oscillator means in said up-converter means for stabilizing operation of said up-converter means.

12. An audio transmission system according to claim 11 including a antenna means operative for radiating said UHF FM frequency signal for reception by a receiver wirelessly to reproduce said audio signal.

13. An audio transmission system according to claim 12 including a microprocessor coupled to said RF means and said up-converter means and operative for controlling operations of said RF means and said up-converter means.

14. An audio transmission system according to claim 13 including an antenna means coupled to said filter means and operative for transmitting said UHF FM frequency signal to said receiver.

15. An audio transmission system according to claim 14 wherein said audio signal is a stereo signal having a left channel signal and a right channel signal, and said RF means includes a multiplex means operative for multiplexing said left channel signal and said right channel signal into a composite audio signal.

16. An audio transmission system according to claim 15 wherein said RF means and said up-converter means are both in the form of a solid state integrated circuit.
